(19) United States
(12) Patent Application Publication
(10) Pub. No.: US 2022/0245458 A1
(43) Pub. Date: Aug. 4, 2022

(54) APPARATUS AND METHOD FOR CONVERTING NEURAL NETWORK

(71) Applicant: ELECTRONICS AND TELECOMMUNICATIONS RESEARCH INSTITUTE, Daejeon (KR)

(72) Inventor: Jae-Bok PARK, Daejeon (KR)

(73) Assignee: ELECTRONICS AND TELECOMMUNICATIONS RESEARCH INSTITUTE, Daejeon (KR)

(21) Appl. No.: 17/485,322

(22) Filed: Sep. 24, 2021

(30) Foreign Application Priority Data
Feb. 3, 2021 (KR) 10-2021-0015589

(51) Int. Cl. G06N 3/08; G06K 9/62; G06K 9/72

(52) U.S. Cl. CPC G06N 3/082; G06K 9/6262; G06K 9/726; G06K 9/723; G06K 9/6288

(57) ABSTRACT

Disclosed herein are an apparatus and method for converting a neural network. The method includes separating neural network data of a source framework to form a tree structure by analyzing the same, converting the neural network data in a tree structure to a neural network optimized for a target framework, classifying training data based on the result of analysis of the neural network data of the source framework, converting the classified training data to the training data structure of the target framework, and creating a neural network and training data of the target framework by combining the converted neural network and the converted training data.

### CROSS REFERENCE TO RELATED APPLICATION

This application claims the benefit of Korean Patent Application No. 10-2021-0015589, filed Feb. 3, 2021, which is hereby incorporated by reference in its entirety into this application.

### BACKGROUND OF THE INVENTION

### 1. Technical Field

The disclosed embodiment relates to technology for converting neural network code and training data such that a neural network and training data are operable in various deep-learning frameworks.

### 2. Description of the Related Art

Deep-learning technology based on Artificial Intelligence (AI) neural networks has been actively researched both domestically and abroad, and the fields of application thereof are expanding to various embedded environments for autonomous cars, unmanned vehicles, image-processing devices, factory automation, and the like. Also, various deep-learning frameworks are currently being developed in order to easily and quickly develop deep-learning neural networks.

When a deep-learning framework is selected, factors, such as the characteristics of a deep-learning framework, a developer's preferences, whether architecture developed using an existing deep-learning framework is present and shared, and the like, may be taken into consideration. However, because respective deep-learning frameworks are customized to be adapted to various application fields, the structures of neural networks are not uniform. Accordingly, it is necessary to structuralize and implement neural networks based on methods customized for respective application fields. That is, because newly developing a neural network so as to be suitable for a desired deep-learning framework requires a lot of effort and time, technology for converting an already developed and trained neural network into another neural network according to a desired framework is required.

Also, because a lot of processing capacity and time are required to train a deep-learning neural network, it is necessary to train the deep-learning neural network in a high-end device equipped with GPUs, and technology enabling conversion to a desired neural network structure, for example, a neural network structure required for low-level programs running on low-specification devices such as embedded systems or a script-based neural network representation, is required.

### SUMMARY OF THE INVENTION

An object of the disclosed embodiment is to convert a neural network and training data that have already been developed in a source framework to be available in various other target frameworks.

Another object of the disclosed embodiment is to convert a neural network and training data developed in a high-specification hardware environment so as to be suitable for a target framework supported in a low-specification hardware environment.

A method for converting a neural network according to an embodiment includes separating neural network data of a source framework to form a tree structure by analyzing the neural network data and converting the neural network data in the tree structure to a neural network optimized for a target framework; classifying training data based on the result of analysis of the neural network data of the source framework and converting the classified training data to the training data structure of the target framework; and creating a neural network and training data of the target framework by combining the converted neural network and the converted training data.

Here, converting the neural network data in the tree structure may include performing lexical and syntactic analysis on the neural network code of the source framework based on a previously stored neural network data structure of the source framework; creating a tree structure formed of instructions and parameters from the neural network code based on the result of the analysis; and converting the instructions and parameters of the created tree structure based on a mapping table in which the instructions and parameters of the target framework are listed.

Here, the method may further include validating the instruction based on whether the instruction is present, and when the instruction is not validated, an instruction error message may be output.

Here, the method may further include validating the ranges and fields of the parameters, and when the ranges or fields of the parameters are not validated, a parameter range error message may be output.

Here, converting the instructions and parameters of the created tree structure may include checking whether an error is present in the structure and operation of the neural network that is converted based on the mapping table, and when there is no error, neural network code, acquired through conversion to the instructions and parameter structure of the neural network of the target framework, may be stored.

Here, performing the lexical and syntactic analysis, creating the tree structure, and converting to the neural network optimized for the target framework may be repeated for each line of neural network instruction code.

Here, converting the classified training data may include classifying the training data based on a variable list acquired by performing the lexical and syntactic analysis; optimizing the classified training data based on user requirements; and converting the optimized training data to the training data structure of the target framework.

Here, converting the classified training data may further include, before optimizing the classified training data, detecting an error through comparison and analysis of respective variables and array coefficients of the training data classified using the variable list and the parameters.

Here, optimizing the training data may be configured to perform at least one of optimization methods for quantization calculation and reduction of the size of a real number.

An apparatus for converting a neural network according to an embodiment includes memory in which at least one program is recorded; and a processor for executing the program. The program may perform separating neural network data of a source framework to form a tree structure by analyzing the neural network data and converting the neural network data in the tree structure to a neural network optimized for a target framework; classifying training data based on the result of analysis of the neural network data of the source framework and converting the classified training data to the training data structure of the target framework; and creating a neural network and training data of the target framework by combining the converted neural network and the converted training data.

Here, converting the neural network data in the tree structure may include performing lexical and syntactic analysis on the neural network code of the source framework based on a previously stored neural network data structure of the source framework; creating a tree structure formed of instructions and parameters from the neural network code based on the result of the analysis; and converting the instructions and parameters of the created tree structure based on a mapping table in which the instructions and parameters of the target framework are listed.

Here, the program may further perform validating the instruction based on whether the instruction is present, and when the instruction is not validated, an instruction error message may be output.

Here, the program may further perform validating the ranges and fields of the parameters, and when the ranges or fields of the parameters are not validated, a parameter range error message may be output.

Here, converting the instruction and parameters of the created tree structure may include checking whether an error is present in the structure and operation of the neural network that is converted based on the mapping table, and when there is no error, neural network code, acquired through conversion to the instructions and parameter structure of the neural network of the target framework, may be stored.

Here, the program may repeatedly perform the lexical and syntactic analysis, creation of the tree structure, and conversion to the neural network optimized for the target framework for each line of neural network instruction code.

Here, converting the classified training data may include classifying the training data based on a variable list acquired by performing the lexical and syntactic analysis; optimizing the classified training data based on user requirements; and converting the optimized training data to the training data structure of the target framework.

Here, converting the classified training data may further include, before optimizing the classified training data, detecting an error through comparison and analysis of respective variables and array coefficients of the training data classified using the variable list and the parameters.

Here, optimizing the training data may be configured to perform at least one of optimization methods for quantization calculation and reduction of the size of a real number.

A method for converting a neural network according to an embodiment may include performing lexical and syntactic analysis on the neural network code of a source framework based on a previously stored neural network data structure of the source framework; creating a tree structure formed of instructions and parameters from the neural network code based on the result of the analysis; converting the instructions and parameters of the created tree structure based on a mapping table in which instructions and parameters of a target framework are listed; classifying training data based on a variable list acquired by performing the lexical and syntactic analysis; optimizing the classified training data based on user requirements; converting the optimized training data to the training data structure of the target framework; and creating a neural network and training data of the target framework by combining the converted neural network and the converted training data.

Here, performing the lexical and syntactic analysis, creating the tree structure, and converting the instruction and parameters of the created tree structure may be repeated for each line of neural network instruction code.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a concept diagram for explaining an apparatus for converting a neural network according to an embodiment;

FIG. 2 is a schematic block diagram of an apparatus for converting a neural network according to an embodiment;

FIG. 3 is a flowchart for explaining conversion to a neural network optimized for a target framework according to an embodiment;

FIG. 4 is a flowchart for explaining optimization of a neural network according to an embodiment;

FIG. 5 is a flowchart for explaining conversion to the training data structure of a target framework according to an embodiment;

FIG. 6 is a view illustrating an example of conversion of a neural network according to an embodiment; and

FIG. 7 is a view illustrating a computer system configuration according to an embodiment.

### DESCRIPTION OF THE PREFERRED EMBODIMENTS

The advantages and features of the present invention and methods of achieving the same will be apparent from the exemplary embodiments to be described below in more detail with reference to the accompanying drawings. However, it should be noted that the present invention is not limited to the following exemplary embodiments, and may be implemented in various forms. Accordingly, the exemplary embodiments are provided only to disclose the present invention and to let those skilled in the art know the category of the present invention, and the present invention is to be defined based only on the claims. The same reference numerals or the same reference designators denote the same elements throughout the specification.

It will be understood that, although the terms “first,” “second,” etc. may be used herein to describe various elements, these elements are not intended to be limited by these terms. These terms are only used to distinguish one element from another element. For example, a first element discussed below could be referred to as a second element without departing from the technical spirit of the present invention.

The terms used herein are for the purpose of describing particular embodiments only, and are not intended to limit the present invention. As used herein, the singular forms are intended to include the plural forms as well, unless the context clearly indicates otherwise. It will be further understood that the terms “comprises,” “comprising,”, “includes” and/or “including,” when used herein, specify the presence of stated features, integers, steps, operations, elements, and/or components, but do not preclude the presence or addition of one or more other features, integers, steps, operations, elements, components, and/or groups thereof.

Unless differently defined, all terms used herein, including technical or scientific terms, have the same meanings as terms generally understood by those skilled in the art to which the present invention pertains. Terms identical to those defined in generally used dictionaries should be interpreted as having meanings identical to contextual meanings of the related art, and are not to be interpreted as having ideal or excessively formal meanings unless they are definitively defined in the present specification.

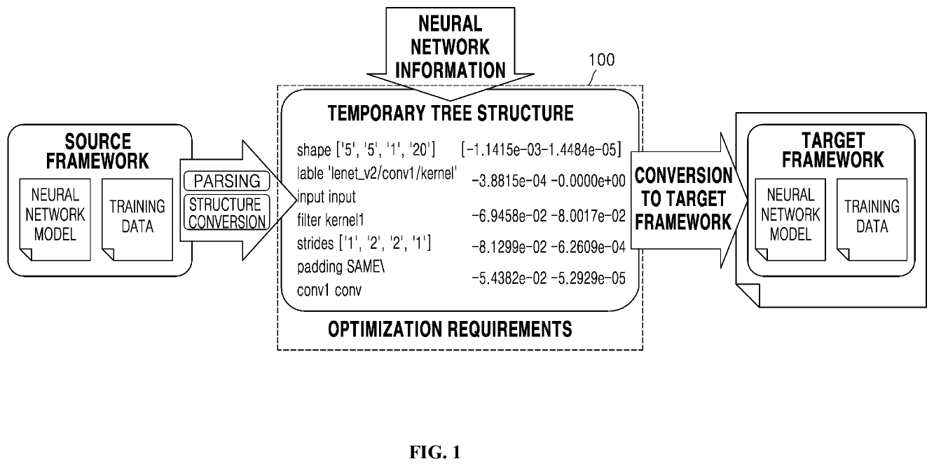

Hereinafter, an apparatus and method according to an embodiment will be described in detail with reference to FIGS. 1 to 7.

FIG. 1 is a concept diagram for explaining an apparatus for converting a neural network according to an embodiment.

Referring to FIG. 1, the apparatus 100 for converting a neural network according to an embodiment converts a neural network and training data developed in a specific deep-learning framework (referred to as a ‘source framework’ hereinbelow) to a neural network and training data available in a desired deep-learning framework (referred to as a ‘target framework’ hereinbelow).

Here, in consideration of various types of deep-learning frameworks, the apparatus 100 for converting a neural network according to an embodiment temporarily structuralizes a neural network in the form of a tree through lexical analysis and syntactic analysis of the neural network and training data of the source framework, thereby enabling fast and easy conversion to a neural network and training data optimized for the target framework.

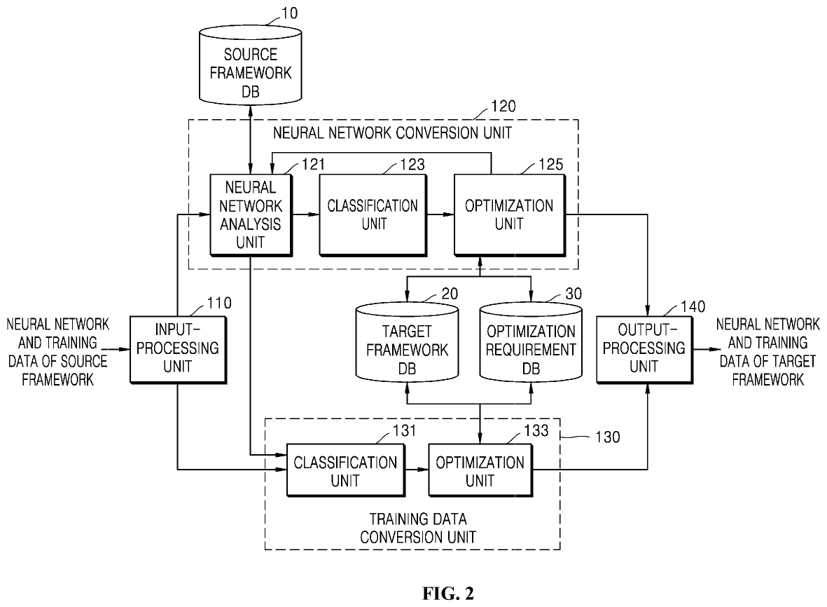

FIG. 2 is a schematic block diagram of an apparatus for converting a neural network according to an embodiment.

Referring to FIG. 2, the apparatus 100 for converting a neural network (referred to as an ‘apparatus’ hereinbelow) may include a source framework DB 10, a target framework DB 20, an optimization requirement DB 30, an input-processing unit 110, a neural network conversion unit 120, a training data conversion unit 130, and an output-processing unit 140.

The source framework DB 10 stores data on the instruction structure of the neural network of the source framework.

The target framework DB 20 stores data on the instruction structure of the neural network of the target framework.

The optimization requirement DB 30 stores requirements for conversion to the target framework, which are input from a user.

The source framework DB 10, the target framework DB 20, and the optimization requirement DB 30 may store data in real time, or may be constructed in advance.

When the neural network and training data of the source framework are input, the input-processing unit 110 inputs the neural network and the training data to the neural network conversion unit 120 and the training data conversion unit 130.

The neural network conversion unit 120 analyzes the neural network data of the source framework, separates the same to form a tree structure, and converts the neural network data in a tree structure to a neural network optimized for the target framework.

Specifically, the neural network conversion unit 120 may include a neural network analysis unit 121, a classification unit 123, and an optimization unit 125.

The neural network analysis unit 121 performs lexical and syntactic analysis on the neural network code of the source framework based on a previously stored neural network data structure of the source framework.

Here, the neural network analysis unit 121 may acquire the previously stored neural network data structure of the source framework from the source framework DB 10.

The classification unit 123 creates a tree structure formed of the instructions and parameters of the neural network code based on the result of analysis performed by the neural network analysis unit 121.

Here, the classification unit 123 separately stores instructions, variables, arrays, and respective argument values, which are classified from the neural network code, thereby creating a neural network layer for creating neural network code.

Here, the neural network conversion unit 120 may further include a component block for validating an instruction based on whether the instruction is present and for outputting an instruction error message when the instruction is not validated.

Here, the neural network conversion unit 120 may further include a component block for validating the ranges and fields of parameters and for outputting a parameter range error message when the ranges or fields of the parameters are not validated.

The optimization unit 125 converts the instructions and parameters in the created tree structure based on a mapping table in which the instructions and parameters of the target framework are listed.

Here, the mapping table may be created in advance and stored in the target framework DB 20.

Here, the optimization unit 125 may check whether an error is present in the structure and operation of the neural network that is converted based on the mapping table. When there is no error, the optimization unit 125 may perform conversion to the neural network instructions and parameter structures of the target framework and store neural network code.

Here, the neural network analysis unit 121, the classification unit 123, and the optimization unit 125 may repeatedly perform sequential operations for each line of the neural network instruction code.

Meanwhile, the training data conversion unit 130 classifies training data based on the result of analysis of the neural network data of the source framework and converts the classified training data to the training data structure of the target framework.

Specifically, the training data conversion unit 130 may include a classification unit 131 and an optimization unit 133.

The classification unit 131 may classify training data based on a variable list that is acquired as the result of lexical and syntactic analysis of the neural network, which is performed by the neural network analysis unit 121.

That is, the training data is stored in the form of an array through classification and analysis of the variables, arrays, and argument values of the neural network. Here, the training data may be protocolized and stored.

The optimization unit 133 optimizes the classified training data based on user requirements and converts the optimized training data to the training data structure of the target framework.

Here, before optimization, the optimization unit 133 may detect an error through comparison and analysis of the respective variables and array coefficients of the training data classified using the variable list and the parameters.

Subsequently, the optimization unit 133 may perform at least one of optimization methods for quantization calculation and reduction of the size of a real number when it optimizes the classified training data based on the user requirements.

The output-processing unit 140 creates a neural network and training data of the target framework by combining the converted neural network and the converted training data and outputs the same.

Hereinafter, a method for converting a neural network, performed by the above-described apparatus 100, will be described.

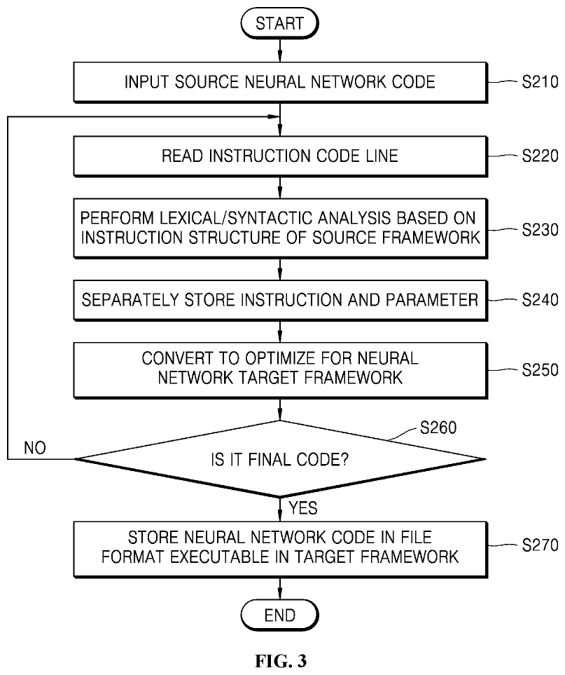

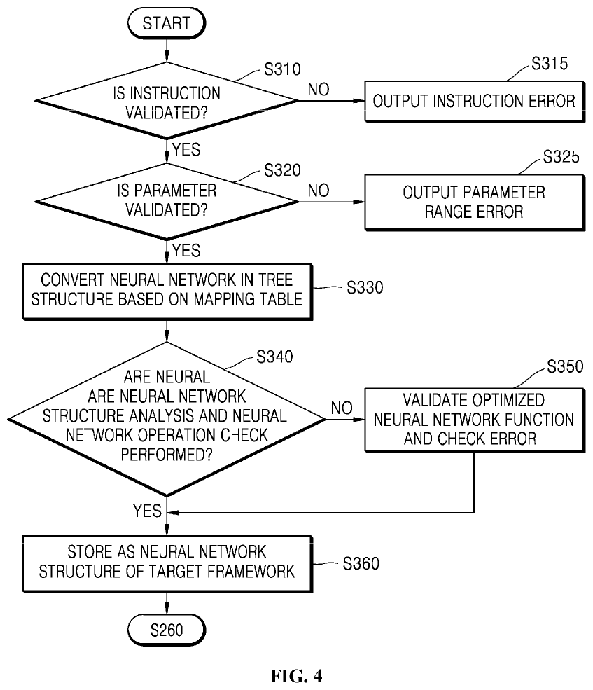

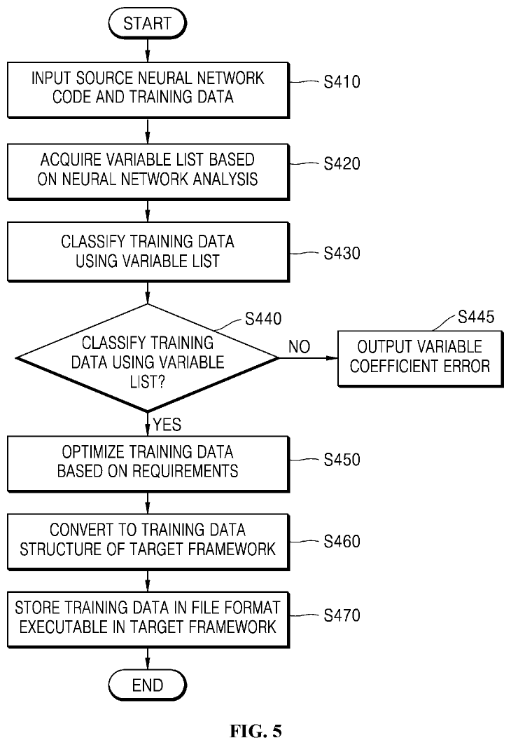

The method for converting a neural network according to an embodiment includes analyzing the neural network data of a source framework, separating the same to form a tree structure, converting the neural network data in a tree structure to a neural network optimized for a target framework (steps illustrated in FIG. 3 and FIG. 4), classifying training data based on the result of analysis of the neural network data of the source framework, converting the classified training data to the training data structure of the target framework (steps illustrated in FIG. 5), and creating a neural network and training data of the target framework by combining the converted neural network and the converted training data.

FIG. 3 is a flowchart for explaining conversion to a neural network optimized for a target framework according to an embodiment, and FIG. 4 is a flowchart for explaining optimization of a neural network based on a tree structure according to an embodiment.

Referring to FIG. 3, when source neural network code is input at step S210, the apparatus 100 reads an instruction code line from the source neural network code at step S220.

Subsequently, the apparatus 100 performs lexical analysis and syntactic analysis on the read instruction code using a previously stored instruction structure of the source framework at step S230, separates variables and parameters from the instruction code, and stores each line in the form of a tree structure at step S240.

The apparatus 100 converts the neural network data in the created tree structure so as to be optimized for the target framework at step S250. This will be described in detail with reference to FIG. 4.

Referring to FIG. 4, the apparatus 100 validates the instruction and determines whether the corresponding instruction is present at step S310.

When it is determined at step S310 that the corresponding instruction is not present, the apparatus 100 outputs a message indicating that an instruction error occurs at step S315.

Conversely, when it is determined at step S310 that the corresponding instruction is present, the apparatus 100 validates the ranges and fields of parameters at step S320.

When it is determined at step S320 that the ranges or fields of the corresponding parameters are not validated, the apparatus 100 outputs a message indicating that a parameter range error occurs at step S325.

Conversely, when it is determined at step S320 that the parameters are validated, the single line of the neural network code may be stored in the form of a tree structure.

Subsequently, the apparatus 100 performs conversion at step S330 by mapping the neural network code in a tree structure to a mapping table.

Here, the mapping table may be previously created before step S210, illustrated in FIG. 3, by listing instructions and parameters using the instruction list of the source framework.

Subsequently, the apparatus 100 analyzes the structure of the converted neural network and checks the operation thereof at step S340.

When it is determined at step S340 that the structure of the converted neural network is problematic or that the operation thereof is erroneous, the apparatus 100 validates the functions of the optimized neural network and checks for errors at step S350.

When it is determined at step S340 that the structure of the converted neural network has no problem and that the operation thereof is normal, the apparatus 100 performs conversion to the neural network instructions and parameter structure of the desired framework and stores the neural network code at step S360.

Referring again to FIG. 3, the apparatus 100 determines whether the instruction code read at step S220 is the last line of the neural network code at step S260.

When it is determined at step S260 that the read instruction code is not the last line of the neural network code, the apparatus 100 goes to step S220 and repeatedly perform steps S220 to S250.

Conversely, when it is determined at step S260 that the read instruction code is the last line of the neural network code, the apparatus 100 stores the optimally converted neural network code as neural network code in the form of a file that is executable in the target framework at step S270.

FIG. 5 is a flowchart for explaining conversion to the training data structure of a target framework according to an embodiment.

Referring to FIG. 5, when the neural network code and training data of the source framework are input at step S410, the apparatus 100 acquires a variable list based on analysis of the neural network at step S420 and classifies the training data based on the acquired variable list at step S430.

Here, the variable list based on analysis of the neural network may be acquired based on the variables and parameters acquired at step S230, as illustrated in FIG. 3.

Here, the classified training data may be temporarily stored.

Subsequently, the apparatus 100 determines whether the respective variables match array coefficients by comparing the same using the variable list and the parameters at step S440.

When it is determined at step S440 that the variables do not match the array coefficients, the apparatus 100 outputs a variable coefficient error at step S445.

Conversely, when it is determined at step S440 that the variables match the array coefficients, the apparatus 100 optimizes the temporarily stored training data based on user requirements at step S450.

Here, optimization methods for quantization calculation and reduction of the size of a real number may be performed in the optimization process.

Subsequently, the apparatus 100 converts the training data using the training data structure of the target framework at step S460 and stores the same in a training data format available in the target framework at step S470.

The neural network and training data converted through the above-described steps are stored so as to be used in the desired framework.

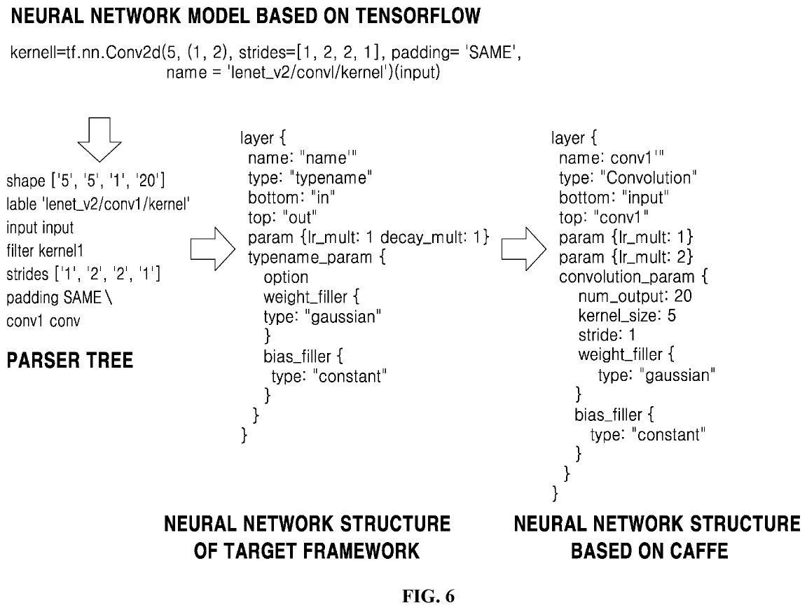

FIG. 6 is a view illustrating an example of conversion of a neural network according to an embodiment.

Referring to FIG. 6, an example in which a source neural network model based on TensorFlow is converted to a target neural network model based on Caffe is illustrated.

When the source neural network model based on TensorFlow is input, a parser tree is created through lexical and syntactic analysis, and an instruction and parameters may be temporarily stored in the form of a tree.

The neural network in a tree structure, temporarily stored as described above, is converted by mapping the same to instructions, variables, and arguments in a previously written mapping table. For reference, some deep-learning frameworks may require a neural network structure along with simple mapping, in which case simple structure-processing is required.

Subsequently, the neural network is optimized based on user requirements, and finally, a neural network model based on Caffe, which is the target framework, is created, whereby neural network code in an executable format may be stored.

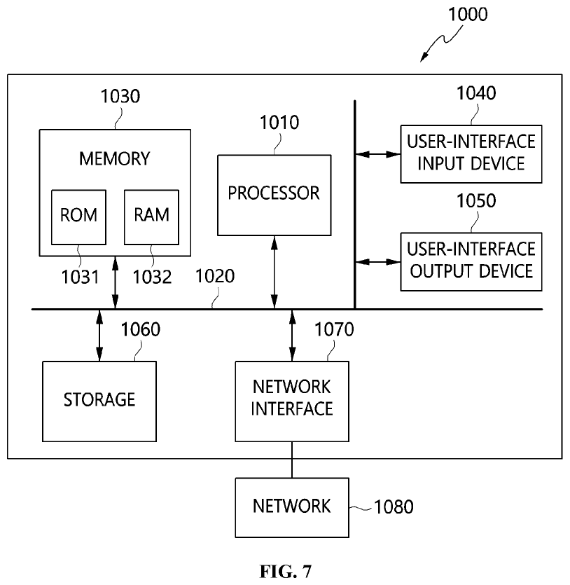

FIG. 7 is a view illustrating a computer system configuration according to an embodiment.

The apparatus 100 for converting a neural network according to an embodiment may be implemented in a computer system 1000 including a computer-readable recording medium.

The computer system 1000 may include one or more processors 1010, memory 1030, a user-interface input device 1040, a user-interface output device 1050, and storage 1060, which communicate with each other via a bus 1020. Also, the computer system 1000 may further include a network interface 1070 connected with a network 1080. The processor 1010 may be a central processing unit or a semiconductor device for executing a program or processing instructions stored in the memory 1030 or the storage 1060. The memory 1030 and the storage 1060 may be storage media including at least one of a volatile medium, a nonvolatile medium, a detachable medium, a non-detachable medium, a communication medium, and an information delivery medium. For example, the memory 1030 may include ROM 1031 or RAM 1032.

According to the disclosed embodiment, a neural network and training data that have already been developed in a source framework may be converted to be available in various other target frameworks. Therefore, versatility enabling application to various frameworks may be provided.

According to the disclosed embodiment, because a neural network and training data developed in a high-specification hardware environment are capable of being converted to be suitable for a target framework supported in a low-specification embedded system, an AI neural network may be easily transplanted to various AI hardware environments. That is, a neural network and training data are converted to low-level code for embedded systems, whereby neural network code that is hard-coded to run a neural network may be created using a low-level language.

According to the disclosed embodiment, the process of specifying and converting neural network code based on the instruction database of a source framework and that of a target framework is specifically presented, and quick conversion may be supported by phasing the conversion process.

Although embodiments of the present invention have been described with reference to the accompanying drawings, those skilled in the art will appreciate that the present invention may be practiced in other specific forms without changing the technical spirit or essential features of the present invention. Therefore, the embodiments described above are illustrative in all aspects and should not be understood as limiting the present invention.

What is claimed is:

1. A method for converting a neural network, comprising:
separating neural network data of a source framework to form a tree structure by analyzing the neural network data and converting the neural network data in the tree structure to a neural network optimized for a target framework;
classifying training data based on a result of analysis of the neural network data of the source framework and converting the classified training data to a training data structure of the target framework; and
creating a neural network and training data of the target framework by combining the converted neural network and the converted training data.

2. The method of claim 1, wherein converting the neural network data in the tree structure comprises:
performing lexical and syntactic analysis on neural network code of the source framework based on a previously stored neural network data structure of the source framework;
creating a tree structure formed of instructions and parameters from the neural network code based on a result of the analysis; and
converting the instructions and parameters of the created tree structure based on a mapping table in which instructions and parameters of the target framework are listed.

3. The method of claim 2, further comprising:
validating the instruction based on whether the instruction is present,
wherein, when the instruction is not validated, an instruction error message is output.

4. The method of claim 2, further comprising:
validating ranges and fields of the parameters,
wherein, when the ranges or fields of the parameters are not validated, a parameter range error message is output.

5. The method of claim 2, wherein:
converting the instructions and parameters of the created tree structure comprises checking whether an error is present in a structure and operation of the neural network that is converted based on the mapping table, and
when there is no error, neural network code, acquired through conversion to instructions and a parameter structure of the neural network of the target framework, is stored.

6. The method of claim 2, wherein:
performing the lexical and syntactic analysis, creating the tree structure, and converting the instructions and parameters of the created tree structure are repeated for each line of neural network instruction code.

7. The method of claim 2, wherein converting the classified training data comprises:
classifying the training data based on a variable list acquired by performing the lexical and syntactic analysis;
optimizing the classified training data based on user requirements; and
converting the optimized training data to the training data structure of the target framework.

8. The method of claim 7, wherein converting the classified training data further comprises:
before optimizing the classified training data, detecting an error through comparison and analysis of respective variables and array coefficients of the training data classified using the variable list and the parameters.

9. The method of claim 7, wherein optimizing the training data is configured to perform at least one of optimization methods for quantization calculation and reduction of a size of a real number.

10. An apparatus for converting a neural network, comprising:
memory in which at least one program is recorded; and
a processor for executing the program,
wherein the program performs
separating neural network data of a source framework to form a tree structure by analyzing the neural network data and converting the neural network data in the tree structure to a neural network optimized for a target framework,
classifying training data based on a result of analysis of the neural network data of the source framework and converting the classified training data to a training data structure of the target framework, and
creating a neural network and training data of the target framework by combining the converted neural network and the converted training data.

11. The apparatus of claim 10, wherein converting the neural network data in the tree structure comprises:
performing lexical and syntactic analysis on neural network code of the source framework based on a previously stored neural network data structure of the source framework;
creating a tree structure formed of instructions and parameters from the neural network code based on a result of the analysis; and
converting the instructions and parameters of the created tree structure based on a mapping table in which instructions and parameters of the target framework are listed.

12. The apparatus of claim 11, wherein:
the program further performs validating the instruction based on whether the instruction is present, and
when the instruction is not validated, an instruction error message is output.

13. The apparatus of claim 11, wherein:
the program further performs validating ranges and fields of the parameters,
wherein, when the ranges or fields of the parameters are not validated, a parameter range error message is output.

14. The apparatus of claim 11, wherein:
converting the instruction and parameters of the created tree structure comprises checking whether an error is present in a structure and operation of the neural network that is converted based on the mapping table, and
when there is no error, neural network code, acquired through conversion to instructions and a parameter structure of the neural network of the target framework, is stored.

15. The apparatus of claim 11, wherein:
the program repeatedly performs the lexical and syntactic analysis, creation of the tree structure, and conversion to the neural network optimized for the target framework for each line of neural network instruction code.

16. The apparatus of claim 11, wherein converting the classified training data comprises:
classifying the training data based on a variable list acquired by performing the lexical and syntactic analysis;
optimizing the classified training data based on user requirements; and
converting the optimized training data to the training data structure of the target framework.

17. The apparatus of claim 16, wherein converting the classified training data further comprises:
before optimizing the classified training data, detecting an error through comparison and analysis of respective variables and array coefficients of the training data classified using the variable list and the parameters.

18. The apparatus of claim 16, wherein optimizing the training data is configured to perform at least one of optimization methods for quantization calculation and reduction of a size of a real number.

19. A method for converting a neural network, comprising:
performing lexical and syntactic analysis on neural network code of a source framework based on a previously stored neural network data structure of the source framework;
creating a tree structure formed of instructions and parameters from the neural network code based on a result of the analysis;
converting the instructions and parameters of the created tree structure based on a mapping table in which instructions and parameters of a target framework are listed;
classifying training data based on a variable list acquired by performing the lexical and syntactic analysis;
optimizing the classified training data based on user requirements;
converting the optimized training data to a training data structure of the target framework; and
creating a neural network and training data of the target framework by combining the converted neural network and the converted training data.

20. The method of claim 19, wherein performing the lexical and syntactic analysis, creating the tree structure, and converting the instruction and parameters of the created tree structure are repeated for each line of neural network instruction code.
